(19) United States
(12) Patent Application Publication
(10) Pub. No.: US 2014/0261859 A1
(43) Pub. Date: Sep. 18, 2014

(54) Automatic Three-Way Diverter Valve

(71) Applicant: John Goodman, Ann Arbor, MI (US)

(72) Inventor: John Goodman, Ann Arbor, MI (US)

(21) Appl. No.: 13/826,567

(22) Filed: Mar. 14, 2013

(51) Int. Cl. B65B 3/12; F16K 11/02

(52) U.S. Cl. CPC B65B 3/12; F16K 11/02
USPC 141/2; 137/625

(57) ABSTRACT

A fluid delivery apparatus including a three-way diverter valve assembly, the three-way diverter valve assembly including a valve housing having a valve body and a valve cap, the valve housing providing a first fluid passageway, a second fluid passageway, and a third fluid passageway, and a resilient valve component within the valve housing, where the resilient valve component is movable from a first position which provides a fluid pathway from the first fluid passageway to the second fluid passageway to a second position which provides a fluid pathway from the third fluid passageway to the first fluid passageway.

### FIELD OF THE INVENTION

The present invention relates to a three-way diverter valve assembly for loading and dispensing materials, such as biological materials, into a delivery apparatus. The diverter valve assembly includes a resilient body that automatically switches from a first position for dispensing from a reservoir to an exit port and a second position for loading from a loading port into a reservoir.

### BACKGROUND OF THE INVENTION

Devices to deliver fluid materials, such as syringes, typically include a dispensing end or tip and a fluid-containing barrel or reservoir, which is sized and shaped to house the fluid material prior to delivery. Delivery assemblies for certain materials, particularly biological materials, typically do not include biological fluids pre-loaded into the device. The device must therefore be loaded with the biological material or materials to be delivered prior to its use. The ability to load and dispense such materials allows the device to be re-used for multiple deliveries, being re-filled each time. In addition, the ability to load a device reduces the risk of contamination or spoilage of the material to be dispensed, since it can remain in a sealed container until prior to loading.

For multi-part compositions, which are formed via the mixing of two or more components, the loading of each separate component into the device is more difficult. These components need to be kept separated when loading them into a delivery assembly, so as to prevent premature mixing and formation of the ultimate composition to be delivered. One such multi-part composition is fibrin, which is formed through the combination of thrombin and fibrinogen. These two precursor components are mixed together and then the resulting fibrin composition is delivered shortly after mixing. Other multi-part compositions include various adhesives, such as acrylates.

Various attempts to load multi-part components into a delivery assembly, such as a syringe, have been made. Typical prior art methods rely upon placing a dispensing tip (or tips) into at least one vial containing fluid, withdrawing the plunger, and thus drawing the fluid into the barrel or reservoir. In another prior method, the components are loaded by connecting the device to a loading component at a location between the dispensing end of the device and the fluid reservoir in the device. The loading component is in fluid communication with the reservoir, allowing fluid to enter the reservoir. This type of assembly, however, often requires the functionality of a diverter valve at the loading port. The diverter valve switches from a loading configuration to a dispensing configuration, so as to restrict flow to the intended site. In the loading configuration, the valve is positioned to allow only communication between the loading port of the device and the reservoirs—thus blocking fluid communication between the loading port and the dispensing end. After loading, the valve can either be removed or can be changed to a dispensing configuration, thereby allowing fluid communication between the dispensing end and the reservoirs while blocking fluid communication between the loading port and the dispensing end.

In such devices, however, switching the valve assembly from one configuration to another is done manually, such as via a switch or turnable element, and can thus lead to loss of some valuable materials due to human error, such as not properly turning the valve. The failure to properly switch configurations may also cause a loss of sterility, particularly with biological components. Further, traditional valves are fairly fragile, and may be broken if the valve is turned in the wrong direction with too much force. In addition, the user may simply forget the step of switching the valve orientation to the proper configuration. If the valve orientation is not changed to the dispensing direction, the biological material will not be properly dispensed. In addition, the precise configurations must be controlled for each loading port in the device, which may include multiple ports for a multi-component material. In addition, each valve in the assembly must be turned, which is susceptible to more human error. Finally, the need to be able to simultaneously coordinate fluid tight connections between storage containers and the device, mechanical engagement of the storage containers with the diverter valve element, and precise diverter valve positioning, complicates manufacturing tolerances and can lead to unsatisfactory performance.

Therefore there is a need for an improved way to enable materials to be loaded into and dispensed from a delivery assembly while avoiding the problems of the prior art. The device of the present invention provides an automated valve assembly.

### SUMMARY OF THE INVENTION

In a first embodiment, there is a fluid delivery device including a three-way diverter valve assembly, the three-way diverter valve assembly including: a valve housing having a valve body and a valve cap, the valve housing providing a first fluid passageway, a second fluid passageway, and a third fluid passageway, each having an access opening; and a resilient valve component within the valve housing; where the resilient valve component is movable from a first position to a second position, the first position providing a fluid pathway between the first fluid passageway and the second fluid passageway, and the second position providing a fluid pathway between the second fluid passageway and the third fluid passageway.

In another embodiment, there is a method of loading a fluid delivery apparatus, including: using a fluid delivery device including: a headpiece including at least one tubular barrel, the tubular barrel including a plunger disposed within an interior of the tubular barrel; an applicator having a lumen in fluid communication with the interior of the tubular barrel; and a three way diverter valve assembly in fluid communication with an interior of the at least one barrel and an interior of lumen of the applicator, the valve assembly including: a valve housing having a valve body and a valve cap, the valve housing providing a first fluid passageway, a second fluid passageway, and a third fluid passageway, each having an access opening; and a resilient valve component within the valve housing; where the resilient valve component is movable from a first position to a second position; the first position providing a fluid pathway between the first fluid passageway and the second fluid passageway and allowing flow of fluid from the valve cap to the barrel interior; and the second position providing a fluid pathway between the second fluid passageway and the third fluid passageway and allowing flow of fluid from the barrel interior to the applicator lumen interior; securing a loading cup to the valve cap, the loading cup having an opening at a bottom portion, where the bottom portion urges the resilient valve component into the first position; at least partially filling the loading cup with a fluid material; and withdrawing the plunger from the barrel, so as to draw the fluid material into the interior of the barrel.

### BRIEF DESCRIPTION OF THE FIGURES

FIG. 1 shows a side view of an assembly including a diverter valve assembly.

FIG. 2 shows a perspective view of an assembly without loading cups.

FIG. 3 shows a perspective view of an assembly with loading cups.

FIG. 4 shows a perspective view of an assembly with loading cups and caps.

FIG. 5 shows a side view of the assembly with components separated.

FIG. 6A shows a close up view of the diverter valve assembly.

FIG. 6B shows the close up view of the diverter valve assembly of FIG. 6A with the components separated.

FIG. 7 shows a close up view of the diverter valve assembly with loading cup attached (in the “loading” configuration).

FIG. 8 shows a perspective view of the diverter valve assembly with components separated.

FIG. 9 shows an alternate embodiment of the valve component.

FIG. 10 shows a diverter valve assembly in the “loading” configuration.

FIG. 11 shows a diverter valve assembly in the “dispensing” configuration.

### DETAILED DESCRIPTION OF THE INVENTION

As used herein, the term “delivery device” or “delivery assembly” includes a dispenser and/or applicator for controlled delivery of a material to an intended site. The term includes, for example, syringe type systems, which use one or more plungers to forcibly dispense at least one fluid to a site, but may include other delivery systems known in the art. The delivery system is desirably sized to be comfortably held and controlled by a user's hands, thus providing the user with the ability to control the placement and dispensing of fluid(s) from the device. The present invention relates to a delivery system for delivering a fluid material, including a multi-part fluid material. The delivery system includes at least one loading port for introducing the fluid material to the device. Most desirably, there is a single loading port for each barrel or reservoir in the device. The invention includes a means for diverting the flow of fluid in at least two different directions: (1) from the loading port to a barrel or reservoir, and (2) from the barrel or reservoir to a delivery tip/port. The invention specifically relates to an automated diverter valve assembly having a loading port for loading fluids into a headpiece, and method of using such a diverter valve assembly to control fluid flow within the delivery device. In desired embodiments, the automated diverter valve assembly is biased into a dispensing configuration, and can be moved into a loading configuration through application of force. One such device that is useful with the present invention is a syringe-type delivery assembly, which delivers the flow of fluid contained in a barrel by depressing a plunger in the direction of the intended site. During loading of fluid, the fluid flows from an external location, such as from a drug vial in a loading cup, through a loading port and diverter valve assembly, and into a barrel. During dispensing of fluid, the fluid flows from a barrel, through the diverter valve assembly, through an applicator lumen, and through a dispensing tip where it can be administered to the intended site.

As used herein, the term “user” refers to a doctor or other professional who is administering the material from the delivery device, such as by depressing the plunger(s) in the device. As used herein, the term “proximal end” will refer to the end of the device in the direction closest to the user, e.g., the person delivering the material from the device. The term “distal end” will refer to the end of the device in the direction furthest from the user, e.g., the person delivering the material from the device. For example, if a device is a typical syringe including a plunger, an applicator, and a delivery tip, the plunger top (i.e., the end which is in contact with the user's hand or finger during use) of the plunger is located at the proximal position, and the delivery tip is located at the distal position. These and other components will be discussed in further detail below as the invention is explained.

Typical single and multi-part syringes as described above are known in the art, and are described, for example, in U.S. Pat. No. 5,814,022, the entire contents of which are incorporated herein by reference. Useful syringes may include, for example, those used in medical applications, such as the delivery of biological components or sealants to body tissue. Other useful syringes include those used in non-medical situations, such as to deliver adhesives or rubberized materials to a site.

The delivery device may deliver any number of fluid components simultaneously to a site, and in some embodiments, the device is a multi-part delivery device to deliver two different fluid components simultaneously. The fluid composition to be delivered through the device may be a biological material, such as fibrin, or it may be a chemical material, such as an acrylate or cyanoacrylate composition. Regardless of the composition or compositions to be delivered, the present invention relates to a diverter valve assembly useful in loading the delivery device with the material or materials prior to use.

A two part delivery syringe using filling cups is depicted in the Figures. Such delivery syringes may be used in the present invention. Two part delivery device 10 generally includes a headpiece 12, an applicator 40 and a delivery conduit 44. Each of the headpiece 12, applicator 40 and delivery conduit 44 are in fluid communication with each other, and are securely connected to each other via a fluid-tight connection when in use. The delivery syringe 10 is generally longitudinal in shape, including a proximal end 10A and a distal end 10B. The headpiece 12 includes at least one, and more desirably a plurality of cylindrical or tubular barrels or reservoirs 18, in which the material or materials to be delivered may be contained until delivery. The barrels 18 may be disposed in any configuration, and in preferred embodiments, are in a side-by-side orientation, with their respective longitudinal axes parallel to each other, extending in the direction of the proximal end 10A to the distal end 10B. Each barrel 18 may be the same size and shape, or they may be different sizes. In some embodiments, it may be desired to include two barrels 18, each having a different volume, thereby allowing differing amounts of fluid to be released from each barrel 18 simultaneously. Each barrel 18 includes an exit port 14 at its distal end, through which the flow of fluid may take place. The headpiece 12 may include a handle 16 at the proximal end for ease of use.

Each barrel 18 includes a controlled delivery component, such as a plunger 20 slidably inserted into each barrel 18. The distal end of the plunger 20 includes a radial seal or piston 22 in contact with the interior surface of the barrel 18 for pushing and pulling the contents into and out of the barrel. Each plunger 20 includes a plunger depressor 24 at the proximal end, which is manipulated by the user to force the plunger 20 into the barrel 18 (by pushing in the direction of distal end 10B) and out of the barrel 18 (by pulling in the direction of proximal end 10A). Each plunger 20 in the device 10 may be connected to each other at or near the plunger depressor 24, so that each plunger 20 may be pushed in or withdrawn from the barrel 18 simultaneously.

The headpiece 12 may be removably connected to the applicator 40 via an attachment mechanism, such that each barrel 18 is in fluid connection with an applicator lumen 42, which is in fluid communication with the delivery conduit 44. Any known attachment mechanism may be used, including snap fit, friction fit, threaded connection, and the like. Desirably, the attachment between the headpiece 12 and applicator 40 is substantially fluid tight. As will be discussed below, a loading port with a diverter valve assembly 25 is desirably located between the headpiece 12 and the applicator 40.

The delivery conduit 44 is a generally hollow tubular structure, which is in fluid communication with the applicator lumens 42 and is securely attached thereto in a fluid-tight connection. The delivery conduit 44 may include a plurality of lumens, each in fluid communication with one applicator lumen 42. The tip of the delivery conduit 44 may be an open nozzle, but may alternatively include an application means, such as a spatula, rolling ball, brush, and/or swab. Any application systems may be used, including those described in U.S. Pat. No. 6,425,704, the entire content of which is incorporated by reference herein.

During use, the user may seek to load fluid(s) into the delivery device 10 and/or dispense fluid(s) from the interior of the delivery device 10. In the case of delivery of biological fluids, maintaining sterility of those components is important. To load fluid into the delivery device 10, the device 10 is equipped with at least one loading port, which creates an open passageway from the exterior of the delivery device 10 into the interior of the headpiece 12, more specifically from the exterior of the delivery device 10 into the interior of a barrel 18. This open passageway is achieved in the present invention through the loading port of a diverter valve assembly 25 and via exit port(s) 14 in the headpiece 12. To achieve loading, one or more loading cups 34 may be used. The loading cup 34 includes a generally hollow interior leading to an open bottom portion 46, which may be threaded for connection. Loading cup 34 may have a further extended bottom portion 47, which may be used to press against one or more components in the diverter valve assembly 25. A loading cup 34 may include additional features to begin, control or restrict the flow of fluid, if desired, such as a spike 38 or other control feature. Loading cups 34 may further be provided with loading cup covers 36, which may be secured to the upper portion of the loading cup 34 and can cover the contents of the loading cup 34. Loading cup cover 36 may be sized to cover a vial if placed within the loading cup 34.

With particular reference to FIGS. 5-6, one embodiment of a diverter valve assembly 25 is described. The diverter valve assembly 25 is sized and shaped to receive a portion of a loading cup 34, such that loading cup 34 can be attached to the device 10, thereby creating an open passageway from the interior of the loading cup 34 to the interior of a barrel 18. The diverter valve assembly 25 includes a generally open valve body 26, into which may be placed a resilient diverter component 28 (also referred to as a “valve component”). Atop the diverter component 28 may be placed a generally tubular valve cap 30, which may optionally have threads to achieve securement of the loading cup 34 thereto. The valve cap 30 and valve body 26 may be securable to each other via any means to create a substantially fluid tight fit. The diverter valve assembly 25 may also include a generally tubular headpiece fitting 27, which may be used to secure an exit port 14 in fluid communication therewith, such as via a friction fit or other secure connection. The diverter valve assembly 25 may also include a generally tubular applicator fitting 29, which may be used to secure an applicator lumen 42 in fluid communication therewith. The valve body 26 is a generally open configuration, with openings in multiple directions where fluid is capable of flowing (e.g., through headpiece fitting 27 or applicator fitting 29), and thus the diverter valve assembly 25 controls the direction of fluid flow. The tubular applicator fitting 29 may also include a generally tubular luer fitting 32, which may be used to attach the applicator lumen 42 thereto in a fluid communication therewith.

A loading cup 34 may be secured to the diverter valve assembly 25, specifically to the valve cap 30, by any desired and known securing means, including through the use of threads, so as to be screwed into or onto the tubular valve cap 30. The loading cup 34 desirably includes bottom portion 46, which includes a series of threads sized and shaped to fit the threaded portion of tubular valve cap 30. The valve cap 30 may include internal or external threads, and the loading cup 34 may include threads to engage with the valve cap 30. Loading cup bottom portion 46 and optional extended bottom portion 47 are generally tubular with an open lumen, allowing the flow of fluid from the interior of the loading cup 34 to the tubular valve cap 30, and thus into valve body 26. The extended bottom portion 47 may be generally cylindrical, but can be any desired shape. As can be seen in FIG. 5, delivery of fluid into the headpiece 12 may be achieved through the use of a vial 48. One vial 48 may be used with one delivery cup 34. Any vial 48 may be used, and preferably the vial is glass, capped with a rubber or plastic septum 49. The loading cup 34 is desirably provided with a vented spike 38 for piercing the septum 49 of the vial 48, allowing the fluid contents of the vial 48 to be withdrawn from the vial 48 in a sterile and controlled manner. Geometry is provided in the bottom of the loading cup 34 to align the axis of the septum 49 with the spike 38 such that the spike 38 reliably hits approximately the center of the septum 49 when the vial 48 is loaded into the loading cup 34. Loading cup cover 36 may be placed over top of the vial 48 when in the loading position, which may provide further security and sterility to the loading. Loading cup 34 may be secured to the tubular valve cap 30, and at least partially filled with a fluid, e.g., the fluid contained in a vial 48. The user may then withdraw a plunger 20 from a barrel 18 associated with the diverter valve assembly 25, thereby pulling the fluid from the drug vial 48 in the loading cup 34, through the bottom 46 of the loading cup 34, through the tubular valve cap 30, past the diverter component 28, into the valve body 26, through the tubular headpiece fitting 27, through the exit port 14, and into the barrel 18. The loading cup 34 may be removed and an optional cap or cover may be placed on the tubular valve cap 30 if desired.

FIGS. 6A-6B show the diverter valve assembly 25 in a close up view. As can be seen, the diverter valve assembly 25 includes the valve body 26, which is a generally hollow configuration having a plurality of exit ports, including tubular headpiece fitting 27 (which leads to the headpiece 12) and tubular applicator fitting 29 (which leads to the applicator lumen 42). The interior of the valve body 26 is sized and shaped to snugly fit the diverter component 28, and atop the diverter component 28, there is provided a tubular valve cap 30. Valve cap 30 and valve body 26 are securable to each other in any desired manner, including via threads, snap fit, friction fit, and the like. As will be explained below, depending upon the level of pressure exerted on the diverter valve assembly 25, the diverter component 28 may be forced “down” (e.g., towards the bottom of the valve body 26) or “up” (e.g., towards the tubular valve cap 30). For example, when a loading cup 34 is secured to the diverter valve assembly 25, the diverter component 28 may be forced “down”, which puts the diverter valve assembly 25 into the “loading configuration”. The loading configuration can best be seen in FIG. 10. When the loading cup 34 is removed, the diverter component 28 may be biased “up”, which puts the diverter valve assembly 25 into the “dispensing configuration”. The dispensing configuration may best be seen in FIG. 11. In one embodiment, the extended bottom portion 46 of the loading cup 34 may be used to exert pressure on the diverter valve assembly 25, which will be described in further detail below.

To load fluid(s) into the headpiece 12, the channel leading from the loading cup 34 to the barrel 18 (via diverter valve assembly 25) must be opened, and a channel leading from the barrel 18 to the applicator lumen 42 must be closed. To dispense fluid(s), the channel leading from the loading cup 34 to the barrel 18 must be closed, and a channel leading from the barrel 18 to the applicator lumen 42 must be opened. This switch has traditionally been achieved through the use of manual valves or switches, which are susceptible to error. Once the dispensing channel is opened, the user depresses one or more plungers 20, and desirably depresses each plunger 20 simultaneously, and the contents of the barrel(s) 18 are forced under pressure through the applicator 40 and out the delivery conduit 44. As such, the mixed composition can be delivered to an intended site. Multi-part syringes are useful in delivery of compositions that require mixing of components immediately prior to delivery, such as certain biological materials and sealant materials. For example, the device 10 may dispense fibrin, which entails mixing of two components (thrombin and fibrinogen) immediately prior to delivery of the final composition. The mixing may take place immediately after each respective fluid is dispensed from the delivery conduit 44. The device 10 may include one or more seals or caps on any open component, so as to protect the interior of the device 10.

The various components described above may be made from any desired materials, and most desirably the materials are biologically stable and inert. In particular, the components of the device 10 should be substantially non-reactive with the fluids to be dispensed therefrom. The various components may be made, for example, from plastic, elastomeric material, glass, metal, and combinations thereof. Each component may be flexible, semi-flexible, semi-rigid, rigid, or reinforced, however, at least a portion of the diverter component 28 should be sufficiently flexible to allow compression and movement. In some embodiments, a spring system may be provided to urge or bias the diverter component 28 in a first or second direction, and in such embodiments, the diverter component 28 may be more rigid.

The present invention improves standard delivery systems by incorporating a diverter valve assembly 25, which automatically switches from a “dispensing configuration” to a “loading configuration” (and vice versa), without the need to manually switch the system.

Desirably, at least two separate loading cups 34 are used to fill at least two barrels 18 in the delivery device 10. FIGS. 2-4, for example, show the device 10 in a two-part system. That is, for example, there are two barrels 18, 18′ and two plungers 20, 20′ contained therein. Each barrel 18, 18′ is associated with its own exit port 14, 14′, which is associated with its own diverter assembly (e.g., valve body 26, 26′; tubular headpiece fitting 27, 27′; tubular applicator fitting 29, 29′; diverter component 28, 28′; tubular valve cap 30, 30′). Each diverter valve assembly 25 is associated with its own loading cup 34, 34′, which can be associated with its own cover 36, 36′. Each diverter valve assembly 25 may include an optional luer fitting 32, 32′, so as to connect an applicator fitting 29 in fluid communication with one applicator lumen 42, 42′. The applicator lumens 42, 42′ lead to the delivery conduit 44, where the fluids are dispensed. The delivery device 10 may include any number of components, but for representative purposes, a two-part fluid delivery device is depicted.

For example, in a two part composition, a first fluid material is loaded into a first loading cup 34 and a second fluid material is loaded into the second loading cup 34′. Each fluid material may be provided through a vial 48, which has a septum 49 to be pierced by spike 38, as explained above. The materials may be any desired material, and in preferred embodiments the materials are fluid. If desired, the material or materials can be reconstituted prior to loading into the first or second loading cups 34, 34′. Prior to loading, the plungers 20, 20′ are depressed into the each barrel 18, 18′ to a desired length, and the loading cups 34, 34′ are secured to the device 10. Desirably, the loading cups 34, 34′ are secured via the threads on the bottom portion 46, but any known securement means may be used. When a loading cup 34 is secured to the device 10, the open interior of the loading cup 34 is in fluid communication with at least one barrel 18 via diverter valve assembly 25. The plunger 20 may then pulled by the user in the proximal direction (toward 10A), thereby drawing in the fluid contents of the loading cup 34 into the barrel 18 with which it is associated. Desirably, a first loading cup 34 is used to fill a first barrel 18 and a second loading cup 34′ is used to fill a second barrel 18′. When the desired amount of material is filled in the barrels 18, 18′, the loading cups 34, 34′ may be removed, and a cap or cover may optionally be placed over the loading port of the delivery valve assembly 25. With fluid(s) contained within the barrels 18, 18′, and the plungers 20, 20′ pulled proximally, the device 10 is fully loaded and ready for delivery of the composition.

FIG. 7 shows the components of a diverter valve assembly 25 of the present invention, with a loading cup 34 secured thereto. With the loading cup 34 secured, the diverter valve assembly 25 is placed in the “loading configuration”. The diverter valve assembly 25 may be used with any desired delivery device, including delivery syringes described above. In the embodiments described herein, the assembly will include two diverter valve assemblies 25 (e.g., for loading two materials), but it is understood that any number of components may be delivered through the present assembly. Desirably, each diverter valve assembly 25 is in fluid communication with a single barrel 18, but more than one diverter valve assembly 25 may be in fluid communication with one barrel 18, if desired. In essence, the diverter valve assemblies 25 each act as a gateway from the loading cup 34 to the interior of the device 10, more particularly the interior of the headpiece 12, and most particularly the interior of a barrel 18. The diverter valve assemblies 25 also each act as a gateway from a barrel 18 to the applicator 40.

The valve cap 30 is a generally tubular structure, which may be tapered if desired, allowing the flow of fluid through its open interior. Tubular valve cap 30 includes a tapered bottom portion, which is sized to snugly fit into valve body 26, providing a fluid communication therebetween. The tubular valve cap 30 may be securely and non-removably attached to the valve body 26, or the tubular valve cap 30 may be removable from the diverter valve assembly 25 if desired. In some embodiments, for example, the tubular valve cap 30 may be secured to the device 10 via an adhesive or other securing means. In embodiments where the tubular valve cap 30 is removable, the attachment of the tubular valve cap 30 to the valve body 26 may be achieved via any desired means, including, for example, a snap fit, friction fit, threaded fit, and the like, which is sized and shaped to join the valve body 26 with the bottom portion of the tubular valve cap 30. The tubular valve cap 30 may include an associated attachment means so as to be secured to the loading cup 34, as explained above.

The open end of the tubular valve cap 30 may optionally include a closure means, such as a cap or other cover (not shown), to secure the interior of the device when not in a loading configuration. When assembled as in FIG. 7, there is an open channel from the interior of the loading cup 34, through its bottom portion 46, through the tubular valve cap 30 and into the valve body 26. From the valve body 26, there are two openings: headpiece fitting 27 and applicator fitting 29. The diverter valve assembly 25 is used to control which opening the fluids flow through.

This control of the flow of fluid of the present invention is achieved through the use of an diverter component 28, which is sized and shaped to be secured in a location between the valve body 26 and the tubular valve cap 30, and controls the flow of fluid in various directions. The diverter component 28 may be attached to the valve body 26, or may optionally be removable to effectuate cleaning or packaging. The diverter component 28 may simply be inserted into the valve body 26 without secure attachment, which aids in easy removal when not in use. The diverter component 28 may be held in position through the use of a pin or bore extending through the bottom of the valve body 26 and into the diverter component 28 (not shown). Fluid flow into and out of the diverter valve assembly 25 can be seen in FIGS. 10 and 11, and will be explained in greater detail below.

The diverter component 28 may be made from any desired material, and in some embodiments it may be made from plastic, rubber, metal, and combinations thereof. Desirably, the diverter component 28 is made from a resilient and deformable material, such as plastic, silicone or elastomeric rubber, which aids in the fit and sealing of the device 10. The diverter component 28 may include one or more compressible areas, such as a compressible bottom region or side region, to allow for force to be applied to the valve body 26 to urge the diverter component 28 into an “up” or “down” position. The diverter component 28 may include a resilient outer coating or sheath, if desired. The diverter component 28 is sized and shaped so as to form a snug fit in the opening between the valve body 26 and the tubular valve cap 30. In some embodiments, the diverter component 28 may have a generally flat, disk-like shape, which may be urged into an “up” or “down” position, such as through the use of a spring on its top or bottom surface. That is, the diverter component 28 may be a disk, which is urged into the “up” configuration through the use of a spring or other biasing component, and is urged “down” through the application of force, such as via attachment of a loading cup 34. In other embodiments, the diverter component 28 may include a generally cylindrical shape with an outwardly extending disk-like flange extending in a middle portion (i.e., between first end and second end).

As can best be seen in FIG. 8, in one embodiment, the diverter component 28 includes a generally cylindrical configuration, with an extended cylindrical flange portion 100, which is located between generally cylindrical lower portion 104 and generally cylindrical upper portion 106. The upper portion 106 may include a series of perpendicular ribs 102, which are disposed above and proximal to the flange portion 100. Ribs 102 are useful in maintaining axial alignment of the diverter component 28 in the upper half of the assembly without impeding the flow of fluid therein. The top of the upper portion 106 may include a channel 108 therein, which allows for the flow of fluid therein. Flange portion 100 includes a lower surface 110 and upper surface 112, each of which are substantially flat. Flange 100 may be deformable and resilient. The lower surface 110 is sized and shaped to mate with a substantially flat surface 114 in the valve body 26. When lower surface 110 is pressed against the flat surface 114 of the valve body 26, a fluid tight seal is created and the diverter valve assembly 25 is in the “loading configuration”. Similarly, the upper surface 112 is sized and shaped to mate with a substantially flat surface 116 in the tubular valve cap 30. When upper surface 112 is pressed against the flat surface 116 of the tubular valve cap 30, a fluid tight seal is created and the diverter valve assembly 25 is in the “dispensing configuration”. Optionally, the bottom ends of the valve body 26 and the diverter component 28 may have an open tubular configuration, which may allow for insertion of a pin or bore (not shown), at the bottom of the valve body 26 and into the bottom of the diverter component 28. This may allow for and maintain axial alignment of the components when assembled. Use of a pin or bore (not shown) may allow for unimpeded compression and deformation of the diverter component 28 to allow for translation of the flange 100 geometry. The bottom of the diverter component 28 may be compressible in the presence of force, but may be extended in the absence of an external force acted thereon. A compressible bottom may be useful to bias the diverter valve assembly 25 in the “dispensing” configuration. In some embodiments, a separate spring device may be placed at the bottom of the diverter component 28 to urge the diverter component 28 into the dispensing configuration in the absence of other force acted thereon.

FIG. 9 shows an alternate embodiment of an diverter component, which may be useful in the invention. With reference to FIG. 9, the embodiment includes diverter component 120, including a generally cylindrical middle portion 122, cylindrical upper portion 132 and cylindrical lower portion 124. The diverter component 120 includes a conical lower portion 126 disposed between the cylindrical middle portion 122 and cylindrical lower portion 124. The diverter component 120 includes a conical upper portion 128 disposed between the cylindrical middle portion 122 and cylindrical upper portion 132. The cylindrical bottom portion 124 may optionally be compressible in the presence of force, but which is extended in the absence of external force acted thereon. The use of a compressible bottom 124 may be useful if the device is to be biased in the dispensing configuration in the absence of force acted on the valve body 120, for example, when the loading cup 34 is not secured to the device 10, the valve body 120 is biased into the dispensing configuration. The angle of each conical portion (126/128) may be modified as desired to create a suitable fluid tight seal against the substantially flat surface 114 in the valve body 26 or the substantially flat surface 116 in the tubular valve cap 30, respectively. In some embodiments, the angle is about 45 degrees, but may be any angle from about 30 degrees to about 60 degrees, as measured with respect to the outer surface of the cylindrical middle portion 122. The upper portion 132 may include a channel 130 therein.

The diverter component 28 may be any desired size, which is determined by the size of the device 10 to be used. In some embodiments, for example, the upper portion 106 may be about 3 to about 10 mm in length, as measured from the top of the diverter component 28 to the flange portion 100. The flange portion 100 may have an axial length of from about 1 mm to about 10 mm (as measured between upper surface 110 and lower surface 112). The lower portion 104 may be from about 3 mm to about 15 mm in length, as measured from the flange portion 100 to the bottom. The diameter of the flange 100 may be any desired size, and in some embodiments is from about 5 mm to about 20 mm.

The diverter component 28 is slidably associated with the valve body 26 and tubular valve cap 30 in such a fashion that the diverter component 28 may be pushed “down” in the direction of the interior of the device 10 (e.g., towards the valve body 26) or “up” in the direction of the exterior of the device 10 (e.g., towards the tubular valve cap 30). In other words, the diverter component 28 may be pushed “up” or “down” to such an extent that it is useful in diverting the flow of fluid into and out of the device 10. The diverter component 28 may be biased towards the tubular valve cap 30, thus into the dispensing configuration. Bias may be achieved through any means, including, for example, through the use of a compressible bottom or through the pin/bore system explained above. The diverter component 28 may be forced into the “down” position by securing loading cup 34 to the diverter valve assembly 25, and in some embodiments, the extended bottom portion 47 of the loading cup 34 may physically contact the diverter component 28 and urge it into the “down” position.

FIGS. 10 and 11 show a diverter valve assembly 25 of the present invention in the “loading configuration” and “dispensing configuration”, respectively. The diverter component 28 may be pressed in either direction via any pressing means. As explained above, the diverter valve assembly 25 is desirably automated, which allows manipulation from the “loading configuration” (FIG. 10) to the “dispensing configuration” (FIG. 11) automatically, without manual manipulation by the user. This is best achieved through the use of a loading cup 34 having a threaded bottom portion 46 and an extended bottom portion 47. When the loading cup 34 is secured to the tubular valve cap 30, such as via screwing the respective threads together, the bottom portion 46 or extended bottom portion 47 pushes the diverter component 28 “down” into the device 10. Since the diverter component 28 is slidably disposed within the assembly, the diverter component 28 is allowed to be pushed toward the valve body 26, which will create a channel from the loading cup 34 to the interior of the barrel 18.

As can be seen in FIG. 10, in the “loading configuration”, the lower surface 110 of the flange 100 is pressed against the flat surface 114 of the valve body 26, creating a fluid tight seal therebetween. At the same time, the upper surface 112 of the flange 100 is separated from the flat surface 116 of the tubular valve cap 30 creating a fluid channel or flow path. The fluid flow path is indicated by the arrow, beginning at the start point 54 (e.g., in the loading cup 34) through the diverter valve assembly 25 and ending at the end point 56 (e.g., into the barrel 18). The loading fluid flow path (start 54, end 56) goes from the loading cup 34, past loading cup bottom 46, through the valve cap 30, past the diverter component 28, into the valve body 26, through the headpiece fitting 27, through exit port 14 and into a barrel 18.

As can be seen in FIG. 11, in the “dispensing configuration”, the lower surface 110 of the flange 100 is separated from the flat surface 114 of the valve body 26, creating a fluid channel or flow path. At the same time, the upper surface 112 of the flange 100 is pressed against the flat surface 116 of the tubular valve cap 30 creating a fluid tight seal therebetween. The dispensing fluid flow path is indicated by the arrow, beginning at the start point 50 (e.g., in the barrel 18) through the diverter valve assembly 25 and ending at the end point 52 (e.g., out the delivery conduit 44). The dispensing fluid flow path (start 50, end 52) goes from the barrel 18, through exit port 14, into valve body 26, past diverter component 28, through applicator fitting 29, and into an applicator lumen 42. Notably, in the “dispensing configuration” of FIG. 11, the loading cup 34 is not attached to the tubular valve cap 30. As such, there is no “downward” pressure acting on the diverter component 28. Since the diverter component 28 is biased in the “upward” configuration, the diverter component 28 is in the “dispensing configuration”.

The loading of the device 10 will now be described. In the “loading configuration”, fluid is permitted to flow from the loading cup 34, through the tubular valve cap 30, past the diverter component 28, through the valve body 26, through the headpiece exit port 14, and into a barrel 18 with which the loading cup 34 is in fluid communication. As explained above, in the “loading configuration”, the diverter component 28 is pressed, under pressure caused by the loading cup 34, to cause a seal between the flange 100 and the flat surface 114 of the valve body 26, blocking the path to applicator fitting 29. However, in this “loading configuration”, there is now a channel at the upper portion of the diverter component 28, allowing the flow of fluid. The channel may be any desired size sufficient to allow the flow of fluid thereby, and in some embodiments measures from about 1 mm to about 50 mm as measured from flange 100 surface to flat surface 116 of the valve cap 30.

The flow of fluid in the “loading configuration” is depicted by loading pathway arrow starting at 54 and ending at 56 in FIG. 10. This allows the user to fill the barrel 18 with fluid. Again, in the “loading configuration”, the lower portion 110 of the flange 100 is firmly pressed against the flat portion 114 of the valve body 26, creating a fluid tight seal and blocking applicator fitting 29, and thus fluid may not flow to or from the applicator 40. Thus, in the “loading configuration”, when the user pulls the plunger 20 in the proximal direction, fluid flows along pathway from start 54 to end 56, and into barrel 18. Due to the seal between the flange 100 and the flat portion 114 of the valve body 26, fluid does not flow in the proximal direction (e.g., towards the applicator 40) from applicator fitting 29. The user can load the fluid into the barrels 18 in this configuration.

The dispensing of fluid from the barrel 18 to the delivery conduit 44 will now be described. As The device 10 can be switched from a “loading configuration” to a “dispensing configuration” quickly, easily and securely with the inventive automatic diverter valve assembly 25. In the “dispensing configuration”, the loading cup 34 is removed, and the diverter component 28 is pushed in the direction of the tubular valve cap 30. In some embodiments, the device may be biased into the dispensing configuration in the absence of any outside force. Such biasing may be achieved through the use of a compressible bottom or compressible element such as a spring disposed on its bottom side or beneath sealing flange 100. Thus, in the absence of outside force acting upon the diverter component 28, the diverter component 28 may be urged in the direction of the tubular valve cap 30.

As can be seen in FIG. 11, in the “dispensing configuration”, the upper portion 112 of the flange 100 is pressed securely against the flat portion 116 of the tubular valve cap 30, creating a fluid tight seal between the two. At the same time, there is now a channel between the lower portion 110 of the flange 100 and the flat surface 114 of the valve body 26. This channel, represented by the start 50 and end 52 in FIG. 11, allows the flow of fluid from the barrel 18 through the applicator 40 and out the delivery conduit 44. The channel may be any desired size sufficient to allow the flow of fluid thereby, and in some embodiments measures from about 1 mm to about 100 mm as measured from flange 100 surface to flat surface 114 of the valve body 26. The user simply depresses the plunger 20, forcing fluid out of the barrel 18, and through the diverter valve assembly 25, through the applicator fitting 29 and out the applicator lumen 42.

The surfaces 110, 112 of the flange 100, and the flat surface 114 of the valve body 26 and the flat surface 116 of the tubular valve cap 30 should be made from materials that will form a fluid tight seal when snugly pressed against each other. The materials may be the same or may be different. Desirably, the materials are biologically stable and inert, such that the fluid to be delivered is not contaminated by contact with these components. For example, the materials may include plastic, rubber, metal, glass, and combinations thereof. A gasket or other additional sealing feature may be included on one or more surfaces.

The diverter component 28 is thus useful for providing or blocking the flow of fluid along at least one of three passageways. The first passageway is located between the tubular valve cap 30 and the diverter component 28 (e.g., between flat surface 116 and flange 100). The second passageway is located between the diverter component 28 and the headpiece exit port 14, via headpiece fitting 27. Thus, the second passageway allows the flow of fluid into the barrel 18. The third passageway is located between the diverter component 28 and the applicator 40, via applicator fitting 29 (between flange 100 and flat surface 114). Thus, the third passageway allows the flow of fluid from the barrel 18 to the applicator 40.

In the “loading configuration”, the loading pathway (starting point 54, ending point 56) fluidly connects the first passageway and second passageway, thus leading fluid from the loading cup 34 to the barrel 18. The loading pathway may have any desired length or width, and may be from about 1 mm to about 100 mm in width, such that it is sufficient to allow the flow of fluid therethrough. The third passageway is blocked in the loading configuration.

In the “dispensing configuration”, the dispensing pathway (starting point 50, ending point 52) is open, and fluidly connects the second passageway and third passageway, thus allowing the flow of fluid from the barrel 18 to the applicator 40. The dispensing pathway may have any desired length or width, and may be from about 1 mm to about 100 mm in width, such that it is sufficient to allow the flow of fluid therethrough. The first passageway is blocked in the dispensing configuration.

The present invention provides a method of not only loading a device 10 with fluid to be delivered, but also of dispensing fluid after the device 10 is loaded. In one embodiment, the device 10 as explained above may initially be substantially free of the fluid to be delivered. The device 10 may have never been used previously to deliver fluid, or it may be cleaned and/or sterilized so as to be substantially free of the fluid to be delivered. As used herein, “substantially free” allows for the presence of a minor amount of fluid, such as any remaining fluid after cleaning or sterilizing. Any fluid or fluids to be delivered may be used, including fluids in the form of liquid, gas, plasma, and combinations thereof. In one embodiment, the fluid to be delivered may be a sealant material, and may be a multi-part sealant material, such as fibrin. Delivery of fibrin requires mixing and dispensing of two individual biological fluids: fibrinogen and thrombin. The loading of the device 10 may include loading each fluid into a separate barrel 18. Thus, in the pre-loaded state, the device 10 is substantially free of fibrinogen and/or thrombin. Other single- and multi-part fluid compositions may be delivered in the present invention, such as acrylates, for example. If the device 10 had previously been used, there may be trace amounts of either composition remaining.

The method includes both loading and dispensing the material. The discussion herein will entail loading and delivery of a two-part composition, including a first fluid and a second fluid, but it will be understood that the method described herein may be used to load and deliver a single-part composition or a composition that entails more than two separate components. For a two-part composition, the device 10 includes two separate barrels 18, 18′ located within the headpiece 12, but again, more than two barrels 18 may be included if more than two separate fluids are to be delivered. The device 10 includes one diverter valve assembly 25 for each barrel 18, and includes one applicator lumen 42 for each barrel 18.

First, the method relates to loading the device 10 with the fluid(s) to be delivered. In a pre-loaded state, the device 10 is substantially free of the fluids to be delivered. Desirably, each diverter component 28, 28′ in the diverter valve assembly 25 is biased into the dispensing configuration. The user presses each plunger 20, 20′ into the interior of each barrel 18, 18′ to a desired level, such that fluids within the barrel are expelled and the barrels 18 are ready to be filled. Loading cups 34, 34′ are then secured to the device 10. In a preferred embodiment, a single loading cup 34 is secured to a single valve cap 30, such as through threaded assembly of the components. Thus, each valve cap 30 includes one loading cup 34 secured thereto.

As the loading cup 34 is secured onto the tubular valve cap 30, the bottom 46 of the cup or the extended bottom portion 47 comes into contact with the assembly, urging the diverter component 28 into the valve body 26. The movement of the diverter component 28 places the first diverter valve assembly 25 into the “loading configuration”, which creates a fluid communication between the interior of first loading cup 34 and first barrel 18. Similarly, the second loading cup 34′ is secured to the assembly and the second assembly is placed into the “loading configuration”. First loading cup 34 may then be filled with a first fluid material to a desired amount, such as through insertion of a vial 48 and piercing of the septum 49 via spike 38. Second loading cup 34′ may be filled with a second fluid material to a desired amount through a separate vial 48. First and second fluid materials may be the same material but are desirably different materials, which are substantially reactive with each other so as to provide a desired resultant composition. In one embodiment, the first fluid material is fibrinogen and the second fluid material is thrombin. The desired amount of the first fluid material may be the same or may be different than the desired amount of the second fluid material.

With the desired amount of first and second fluid materials contained within first and second loading cups 34, 34′, and with each diverter component 28 associated therewith in the “loading configuration”, thus creating loading passageway from each cup 34, 34′ to its associated barrel 18, 18′, the user may withdraw each plunger 20, 20′ in the device 10 so as to introduce fluid into the interior of first and second barrels 18, 18′ with the first and second fluid materials, respectively. The barrels 18, 18′ may be filled with substantially equal amounts of materials, or they may contain differing amount of materials. For example, it may be desired that first barrel 18 include a greater amount of a first material, such as fibrinogen, than the amount of second material, such as thrombin, contained in second barrel 18′. This may be achieved in any desired way, such as by having barrels 18 with differing volumes or inner diameters or by simply loading a first cup 34 with less fluid than second cup 34′.

After the step of introducing fluid into each barrel 18, the device 10 is now in the loaded state. In the loaded state, a desired amount of first and second fluids are contained within the interior of first and second barrels 18, 18′, respectively, and their respective plungers 20, 20′ are withdrawn towards the proximal end 10A of the device 10. Since the loading cups 34, 34′ are still secured to the valve caps 30, 30′, the diverter component 28 is still urged into the “loading configuration”. At this point, the loading cups 34, 34′ may optionally be removed from the apparatus, or may remain secured. A cover or seal may be placed over the loading cups 34, 34′ if desired. Alternatively, the loading cups 34, 34′ may be removed, and one or more covers or seals may be placed onto the valve caps 30, 30′, if desired.

The invention also relates to a method of dispensing a fluid composition from an device 10. To achieve dispensing of fluid, the device 10 should first be put into a “dispensing configuration”, which entails moving the diverter component 28 into the “dispensing configuration”, as explained above and seen in FIG. 11. Movement of diverter component 28 may be achieved through any means, and most desirably is moved via an automated system, such as springs, switches, pin, bore, or biased force, and the like. Movement of the diverter component 28 may be achieved by simply removing the loading cups 34, 34′ from the device 10, and allowing the diverter component 28 to be biased into the “dispensing configuration”. In the “dispensing configuration”, dispensing passageway (starting point 50, ending point 52) is opened and allows fluid communication between the interior of the barrel 18 to the applicator lumen 42 with which it is associated. In the dispensing configuration, the loading passageway is blocked, preventing the flow of fluid from the barrel 18 to the valve cap 30.

While in the “dispensing configuration”, the user may then press on one or more plungers 20, pushing the plunger 20 through the barrel 18 with which it is associated in the distal direction, thereby forcing the fluid contained within each barrel 18 in the distal direction. Since the diverter component 28 is in the dispensing configuration, dispensing passageway is open, and the fluid from each barrel 18 is allowed to flow through the headpiece fitting 27, past its respective diverter component 28, through its respective applicator fitting 29, into the applicator lumen 42, where each fluid material may be dispensed through a delivery conduit 44. Mixing of the components may take place immediately upon dispensing through the delivery conduit 44.

The various components of the device 10, including headpiece 12, applicator 40, barrel 18, plunger 20, valve body 26, valve cap 30, diverter component 28, and loading cup 34 may each individually be removable from the assembly if desired, to allow for packaging or cleaning of the apparatus. The invention may further include a kit, which includes the components of the device 10 described above. The kit may further include a set of instructions to instruct the user how to assemble and use the various components thereof. Alternatively, several components may be non-removably secured to the device 10, which may provide easier handling and use by the user.

What is claimed is:

1. A fluid delivery device comprising a three-way diverter valve assembly, the three-way diverter valve assembly comprising:
(i) a valve housing having a valve body and a valve cap, said valve housing providing a first fluid passageway, a second fluid passageway, and a third fluid passageway, each having an access opening; and
(ii) a resilient valve component within said valve housing;
wherein the resilient valve component is movable from a first position to a second position, said first position providing a fluid pathway between the first fluid passageway and the second fluid passageway, and said second position providing a fluid pathway between the third fluid passageway and the first fluid passageway.

2. The fluid delivery device of claim 1, wherein the resilient valve component within said valve housing has a first end; a second end; and an outwardly extending flange between the first end and second end.

3. The fluid delivery device of claim 1, wherein the resilient valve component moves from the second position to the first position in response to a force applied to the resilient valve component.

4. The fluid delivery device of claim 1, wherein said fluid delivery apparatus comprises said three-way diverter valve assembly, a tubular barrel, and an applicator.

5. The fluid delivery device of claim 1, wherein said resilient valve component is secured to one of said valve cap and said valve body.

6. The fluid delivery device of claim 4, wherein said first passageway is located at a position between a surface of the resilient valve component and the tubular barrel.

7. The fluid delivery device of claim 4, wherein said second passageway is located at a position between a surface of the resilient valve component and the applicator.

8. The fluid delivery device of claim 4, wherein said third passageway is located at a position between a surface of the resilient valve component and the valve cap.

9. The fluid delivery device of claim 1, wherein said resilient valve component comprises an elastomeric material.

10. The fluid delivery device of claim 1, wherein the resilient valve component is biased into the first position in the absence of outside force.

11. The fluid delivery device of claim 1, further comprising a loading cup configured to be secured to said valve cap.

12. The fluid delivery device of claim 11, wherein the loading cup comprises an extended bottom portion which pushes against said resilient valve component, urging said resilient valve component into the second position.

13. The fluid delivery device of claim 1, wherein the first position is a dispensing configuration.

14. The fluid delivery device of claim 1, wherein the second position is a loading configuration.

15. The fluid delivery device of claim 1, wherein said fluid delivery apparatus is a multi-component applicator.

16. The fluid delivery device of claim 15, wherein said fluid delivery apparatus comprises a first tubular barrel and a second tubular barrel.

17. The fluid delivery device of claim 16, wherein said first tubular barrel is in fluid communication with a first diverter valve assembly and said second tubular barrel is in fluid communication with a second diverter valve assembly.

18. A method of loading a fluid delivery apparatus, comprising:
(i) using a fluid delivery device comprising:
(1) a headpiece including at least one tubular barrel, said tubular barrel including a plunger disposed within an interior of the tubular barrel;
(2) an applicator having a lumen in fluid communication with said interior of said tubular barrel; and
(3) a three way diverter valve assembly in fluid communication with an interior of said at least one barrel and an interior of lumen of said applicator, said valve assembly comprising:
(i) a valve housing having a valve body and a valve cap, said valve housing providing a first fluid passageway, a second fluid passageway, and a third fluid passageway, each having an access opening; and
(ii) a resilient valve component within said valve housing having a first end; a second end; a flange between said first end and said second end; wherein the resilient valve component is movable from a first position to a second position; said first position providing a fluid pathway between the first fluid passageway and the second fluid passageway and allowing flow of fluid from said barrel interior to said applicator lumen interior; and said second position providing a fluid pathway between the third fluid passageway and the first fluid passageway and allowing flow of fluid from said valve cap to said barrel interior;
(ii) securing a loading cup to said valve cap, said loading cup having an open interior and an opening at a bottom portion, wherein said bottom portion urges said resilient valve component into said second position;
(iii) placing a fluid material within the interior of said loading cup; and
(iv) withdrawing said plunger from said barrel, so as to draw said fluid material into the interior of said barrel.

19. The method of claim 18, wherein said valve cap comprises a series of external threads and said loading cup comprises a series of internal threads.

20. The method of claim 18, wherein said first passageway is located at a position between a surface of the resilient valve component and the tubular barrel.

21. The method of claim 18, wherein said second passageway is located at a position between a surface of the resilient valve component and the applicator.

22. The method of claim 18, wherein said third passageway is located at a position between a surface of the resilient valve component and the valve cap.

23. The method of claim 18, wherein said first position is a dispensing configuration and said second position is a loading configuration.

24. The method of claim 18, further comprising the step of removing said loading cup from said fluid delivery device, wherein said step of removing said loading cup allows said resilient valve component to move into said first position.

25. The method of claim 18, wherein said fluid delivery device comprises a first tubular barrel and a second tubular barrel, wherein each of said tubular barrels is associated with a separate three way diverter valve assembly.
